(19) United States
(12) Patent Application Publication
(10) Pub. No.: US 2024/0009618 A1
(43) Pub. Date: Jan. 11, 2024

(54) Apparatus and Method for Carbon Dioxide Recovery

(71) Applicant: Air Products and Chemicals, Inc., Allentown, PA (US)

(72) Inventors: Ranajit Ghosh, Macungie, PA (US); Mark Daniel D'Agostini, Allentown, PA (US)

(73) Assignee: Air Products and Chemicals, Inc., Allentown, PA (US)

(21) Appl. No.: 18/199,411

(22) Filed: May 19, 2023

Related U.S. Application Data
(60) Provisional application No. 63/358,914, filed on Jul. 7, 2022.

(51) Int. Cl. B01D 53/62; B01D 53/75; B01D 53/50; B01D 53/96

(52) U.S. Cl. CPC B01D 53/62; B01D 53/75; B01D 53/50; B01D 53/96; B01D 2251/604; B01D 2257/302; B01D 2257/504; B01D 2258/0241; B01D 2258/0283; B01D 2259/80

(57) ABSTRACT

An apparatus and process for use of an alkaline reagent (e.g. sodium hydroxide, NaOH, potassium hydroxide, KOH, etc.) to facilitate removal of carbon dioxide (CO2) from flue gas output from a glass melting operation. The CO2 removed from the flue gas can be in carbonates formed in the reaction of the reagent with the flue gas, which can be used in glass melting operations. A portion of the flue gas can also be liquefied in some embodiments to produce a liquefied CO2 stream for other uses. In some embodiments, a portion of the carbonate generated from the CO2 removal process can be heated (e.g. in an indirect heat exchange process) to liberate the CO2 for feeding the liberated CO2 to a liquefaction process while a resultant oxide formed via the CO2 liberation can be hydrolyzed to regenerate the alkaline reagent for subsequent use in the CO2 removal process.

### CROSS-REFERENCE TO RELATED APPLICATIONS

This application claims the priority of U.S. Provisional Application No. 63/358,914 filed on Jul. 7, 2022, which is incorporated by reference herein in its entirety.

### FIELD

The present innovation relates to apparatuses and processes for the recovery of carbon dioxide (CO₂) from a flue gas emitted from glass melting operations.

### BACKGROUND

Glass production can result in a significant generation of greenhouse gas emissions. For example, emissions from glass manufacturing in about 374 facilities located in the United States and Puerto Rico were estimated to be 4,425,269 metric tons of carbon dioxide equivalent in 2004.

As part of improving sustainability of manufacturing operations and reducing CO₂ footprint, different post-combustion capture (PCC) technologies are being evaluated. Several liquid solvent-based absorption processes (amines, ionic liquids, hot potassium carbonate, chilled ammonia etc.) have been studied.

In amine based absorption processes, the acid gas is brought in direct contact with a lean solvent inside an absorbent column and the CO₂ is desorbed in a subsequent step, with regeneration of the solvent. The advantages of an amine-based absorbent like Monoethanolamine (MEA) is its low cost and high chemical reactivity to CO₂. However, amine-based technologies suffer from significant energy consumption, sizeable footprint, corrosion of equipment and oxidative & thermal degradation. Membrane-based contactors for gas/liquid separation have also been employed in place of traditional absorbents, which helps with reduction of footprint, capital and operating costs, but they also suffer from wetting, fouling and degradation issues.

More recently, a slew of solid sorbents (activated carbonaceous materials, microporous silica or zeolites, polymeric resins and MOFs) has been proposed. However, this type of technology's technical and commercial feasibility is yet to be established.

### SUMMARY

We determined that the emission of greenhouse gases from glass manufacturing primarily occurs as a consequence of two sources: (1) energy input required to heat and melt raw materials used to make glass, which is primarily silica, lime, and soda ash, during the melting process that is often provided by combustion of natural gas or other fuel and (2) limestone (CaCO3), dolomite (CaMg(CO3)2), soda ash (Na2CO3) and/or potassium carbonate (K2CO3), which are some of the primary raw materials added to silica during the glass melting process to make glass. CO₂ is formed from combustion of the fuel and makes up about two thirds (⅔) of the overall greenhouse gas emissions from glass manufacturing. The remaining portion of the CO₂ emissions is primarily from the limestone, dolomite, soda ash and/or potassium carbonate constituents added to the silica to make the glass as CO₂ is formed during the heating of these carbonates (e.g. CaCO3, CaMg(CO3)2, Na2CO3 and/or K2CO3) and is included in the flue gas output as an exhaust stream from the glass manufacturing process.

We have also recognized that there are specific cost, maintenance and footprint issues associated with amine-based PCC technologies being implement in conjunction with glass manufacturing. Also, flue gas from glass plants presents additional challenges. These include low flue gas pressure (˜1 atm), low concentration of CO₂ in the flue gas (typically about 15% by volume,“vol %”) and small size difference among the gas molecules. Conversion of air-fuel furnaces to oxy-fuel can help increase the CO₂ concentration, but the higher temperature flue gas is typically diluted with air additions to decrease its temperature before particulate and acid gases are removed. The CO₂ concentration in the flue gas, consequently, can fall to similar levels as air-fuel furnaces, which can make the economics of the CO₂ recovery more challenging.

We determined that an additional challenge related to the CO₂ recovery from flue gases from glass manufacturing has been the economical use case for CO₂. While sequestration can provide a viable option for disposal of the CO₂, this can be limited to certain areas with access to a CO₂ pipeline or favorable geology for sequestration. Most glass manufacturing facilitates are in locations without access to a pipeline or favorable geology. Therefore sequestration will unlikely be an economical option unless significant penalties are assessed on CO₂ emissions in the future.

We determined that glass melting operations (e.g. operations of one or more glass melting furnaces) can be adapted to address the above noted problems to provide an economical solution for CO₂ recapture to provide significantly reduced greenhouse gas emissions from glass manufacturing operations. Embodiments can utilize an alkaline reagent (e.g. calcium hydroxide, Ca(OH)2, sodium hydroxide, NaOH or potassium hydroxide, KOH) for CO₂ capture. The reagent that is used can facilitate formation of carbonates (e.g. CaCO3,Na2CO3 or K2CO3) used as at least one raw material for glass production so the captured CO₂ is within the formed carbonates that can be subsequently recycled to the glass manufacturing process as a feed for the process.

Embodiments can also provide improved CO₂ capture capacity. For example, the CO₂ absorption capacity of NaOH solution is higher than that of MEA, which can be used in amine based PCC technologies. The theoretical amount of MEA and NaOH to capture a ton of CO₂ is 1.39 and 0.9 tons, respectively (e.g. it can take much less NaOH to capture a ton of CO₂ as compared to MEA).

In certain glass melting processes that utilize K2CO3 (potassium carbonate) as part of the feed batch of raw material to form the glass, the reagent can be KOH to capture CO₂ instead of NaOH depending on the feed batch of raw material for forming glass to be used by a manufacturer.

The alkaline reagent discussed herein can be referred to as XOH, where X can be Na or K such that XOH can refer to KOH or NaOH. In some applications, XOH can also refer to Ca(OH)2.

For glass melting furnaces that have been fully converted to oxy-fuel heating, embodiments of our proposed solution utilizing at least one alkaline reagent can be applied to address the challenges of economical post-combustion CO₂ capture by combining the below listed step (iv) with one or more of the other below listed steps:
(i) cooling high-temperature flue gases from the glass melting furnace using water spray with or without dilution air to retain a higher concentration of CO₂ in the flue gas stream;
(ii) removal of acid gas and particulates using a dry sulfur scrubber and electrostatic precipitator;
(iii) heat exchange the cleaned flue gas to heat one or more of oxygen (O₂), natural gas (methane, CH₄), cullet & batch;
(iv) reacting a portion of the flue gas stream with XOH reagent to produce at least one carbonate (e.g. CaCO3, Na2CO3 or K2CO3) which then can be utilized as a raw material in the glass melting process; and
(v) condensing a portion of the flue gas stream to produce a liquefied CO2 stream for other uses.

In another embodiment, a high-temperature filter device (e.g. a candle filter, a filter device that has an operating temperature over 500° C., over 600° C., over 700° C., in a range of 500° C.-900° C., in a range of 600° C.-900° C., or in a range of 700° C. to 900° C., etc.) can be used for particulate removal instead of an electrostatic precipitator. In such an embodiment, heat exchange of the flue gas can occur after the high-temperature filter device processing and prior to acid gas removal.

In yet another embodiment, a portion of the carbonate generated via use of the at least one alkaline reagent can be heated in an indirect heat exchange process to liberate the CO₂ from the formed carbonate(s) for sending the CO₂ for liquefaction, while the oxide(s) (X2O or XO)) formed as a result of CO₂ liberation can be hydrolyzed to regenerate the alkaline reagent. The regenerated alkaline reagent can then be recycled for subsequent use in the SO2 removal processing, and/or CO₂ capture processing.

For regenerative air-fuel furnaces or regenerative air-fuel furnaces with O2 enrichment, lancing or boosting, embodiments of the proposed solution can be implemented by combining the below listed step (iii) with the below listed step (i) and/or step (ii)

(i) removal of acid gas using a dry sulfur scrubber or wet sulfur scrubber employing XOH solvent spray

(ii) removal of particulates using a particulate filter (e.g. an electrostatic precipitator or baghouse filter); and

(iii) reacting a portion of the flue gas stream with XOH reagent to produce at least one carbonate (e.g. CaCO3,Na2CO3 or K2CO3), which then can be utilized as a raw material in the glass melting process.

In a first aspect, a method of recovering carbon dioxide (CO2) from a flue gas output from a furnace being operated to melt glass can include feeding the flue gas to a CO2 capture unit after the flue gas is treated via at least one process gas treatment element (PGTE) positioned between the furnace and the CO2 capture unit, treating a first portion of the flue gas with at least one alkaline reagent within the CO2 capture unit so that CO2 of the first portion of the flue gas reacts with the alkaline reagent to form at least one carbonate material, and feeding at least a portion of the carbonate material from the CO2 capture unit to the furnace for mixing with other feed material for forming molten glass in the furnace.

In a second aspect, the at least one alkaline reagent can include XOH, wherein the X is Na or K or can include calcium hydroxide (Ca(OH)2), sodium hydroxide (NaOH) or potassium hydroxide (KOH).

In a third aspect, the carbonate material can include limestone (CaCO3), soda ash (Na2CO3) or potassium carbonate (K2CO3).

In a fourth aspect, the one or more PGTEs can include a candle filter, a high-temperature filter device, a SO2 removal unit and an electrostatic precipitator that is positioned between the SO2 removal unit and the CO₂ capture unit, SO2 removal unit, an acid gas removal unit, an electrostatic precipitator, a baghouse, or combinations thereof. Other PGTEs or combinations of PGTEs can also be included.

In a fifth aspect, embodiments of the method can include passing the flue gas through at least one heat exchanger to heat at least one of a flow of fuel and an oxidant flow before the first portion of the flue gas is fed to the CO2 capture unit and after the first portion of the flue gas is output from the at least one PGTE.

In a sixth aspect, embodiments of the method can include feeding a first portion of the carbonate material output from the CO2 capture unit to the furnace and regenerating a second portion of the carbonate material output from the CO2 capture unit to form the at least one alkaline reagent from the second portion of the carbonate material.

In a seventh aspect, the method can also include feeding a second portion of the flue gas output from the at least one PGTE to a CO2 liquefaction system to liquefy CO2 within the second portion of the flue gas.

In an eighth aspect, the at least one PGTE can be fed at least one alkaline reagent to treat the flue gas upstream of the CO2 capture unit.

A ninth aspect can include the first aspect and at least one of the second aspect third aspect, fourth aspect, fifth aspect, sixth aspect, seventh aspect, eighth aspect, or a combination of such aspects.

In a tenth aspect, an apparatus for capturing carbon dioxide (CO2) from a flue gas output from a melting furnace is provided. The apparatus can include a CO2 capture unit positionable downstream of the furnace to receive a first portion of flue gas output from the furnace. The CO2 capture unit can be configured so that the first portion of the flue gas reacts with at least one alkaline reagent within the CO2 capture unit so that CO2 of the first portion of the flue gas reacts with the at least one alkaline reagent to form at least one carbonate material. The CO2 capture unit can be positionable such that at least a portion of the carbonate material is outputtable from the CO2 capture unit to feed the carbonate material to the furnace.

In an eleventh aspect, the at least one alkaline reagent utilizable in the apparatus can include calcium hydroxide (Ca(OH)2), sodium hydroxide (NaOH) and potassium hydroxide (KOH).

In a twelfth aspect, the carbonate material can include limestone (CaCO3), soda ash (Na2CO3) and/or potassium carbonate (K2CO3).

In a thirteenth aspect, the CO2 capture unit can include at least one reactor.

In a fourteenth aspect, at least one process gas treatment element (PGTE) can be positionable between the CO2 capture unit and the furnace to receive the flue gas output from the furnace to treat the flue gas before the first portion of the flue gas is fed to the CO2 capture unit.

In a fifteenth aspect, at least one heat exchanger can be positionable between the at least one PGTE and the CO2 capture unit so that flue gas output from the at least one PGTE is passed through the at least one heat exchanger to reduce a temperature of the flue gas before the first portion of the flue gas is fed to the CO2 capture unit.

In a sixteenth aspect, at least one acid gas removal unit can be positionable to receive the flue gas upstream of the CO2 capture unit.

In a seventeenth aspect, a CO2 liquefaction system can be positionable to receive a second portion of the flue gas that is split from the first portion of the flue gas after the flue gas is output from the at least one PGTE.

In an eighteenth aspect, a first portion of the carbonate material can be feedable to the furnace and there can also be a second portion of the carbonate material. The apparatus can include an alkaline reagent regeneration system downstream of the CO2 capture unit to receive the second portion of the carbonate material to form the at least one alkaline reagent from the second portion of the carbonate material.

In a nineteenth aspect, the apparatus can include a CO2 liberation device that liberates CO2 from the carbonate material to form oxides and a hdyrolization unit to hydrolyze the oxides outputtable from the CO2 liberation device to form the at least one alkaline reagent such that the formed at least one alkaline reagent is feedable to the CO2 capture unit.

In a twentieth aspect, the apparatus of the eleventh aspect can include one or more of the twelfth through nineteenth aspects. For example, the eleventh aspect can be combined with the twelfth aspect, the thirteenth aspect, the fourteenth aspect, the fifteenth aspect, the sixteenth aspect, the seventeenth aspect, the eighteenth aspect, and/or the nineteenth aspect.

In a twenty-first aspect, a method of recovering carbon dioxide (CO2) from a flue gas output from a furnace or reactor is provided. Embodiments of the method can include feeding the flue gas to a CO2 capture unit after the flue gas is treated via at least one process gas treatment element (PGTE) positioned between the furnace or reactor and the CO2 capture unit, treating a first portion of the flue gas with at least one alkaline reagent within the CO2 capture unit so that CO2 of the first portion of the flue gas reacts with the alkaline reagent to form at least one carbonate material, feeding a first portion of the carbonate material from the CO2 capture unit to an alkaline reagent regeneration system, reacting the first portion of the carbonate material with hydrated lime (Ca(OH)2) in a reagent regeneration reactor of the alkaline reagent regeneration system to precipitate calcium carbonate (CaCO3) and liberate the alkaline reagent for feeding to the CO2 capture unit, heating the CaCO3 in a CO2 liberation unit or a lime kiln to liberate CO2 from the CaCO3 and generate calcium oxide (CaO), and hydrolyzing the CaO to form Ca(OH)2 to feed the formed Ca(OH)2 to the reagent regeneration reactor of the alkaline reagent regeneration system.

In a twenty-second aspect, an apparatus can be provided for capturing carbon dioxide (CO2) from a flue gas output from a furnace or reactor. Embodiments of the apparatus can include a CO2 capture unit positionable downstream of the furnace or reactor to receive a first portion of flue gas output from the furnace. The CO2 capture unit can be configured so that the first portion of the flue gas reacts with at least one alkaline reagent within the CO2 capture unit so that CO2 of the first portion of the flue gas reacts with the at least one alkaline reagent to form at least one carbonate material. The apparatus can also include an alkaline reagent regeneration system downstream of the CO2 capture unit. The alkaline reagent regeneration system can include a regeneration reactor positioned to receive the carbonate material to react the carbonate material with hydrated lime (Ca(OH)2) to precipitate calcium carbonate (CaCO3) and liberate the alkaline reagent for feeding to the CO2 capture unit, a CO2 liberation unit positioned to receive the CaCO3 from the regeneration reactor of the alkaline reagent regeneration system to liberate CO2 from the CaCO3 and generate calcium oxide (CaO), and a hydrolysis unit positioned to receive the CaO to hydrolyze the CaO to form Ca(OH)2 so the formed Ca(OH)2 is feedable to the regeneration reactor.

In a twenty-third aspect, the twenty-second aspect or the twenty-first aspect can be adapted so the at least one alkaline reagent can include XOH, wherein the X is Na or K.

In a twenty-fourth aspect, the twenty-second aspect or the twenty-first aspect can be adapted to utilize or include at least one PGTE.

Other details, objects, and advantages of apparatuses and processes for the recovery of CO2 from a flue gas emitted from glass melting operations, glass melting systems that can incorporate such apparatuses and/or processes, glass manufacturing plants, glass manufacturing furnace arrangements, and methods of making and using the same will become apparent as the following description of certain exemplary embodiments thereof proceeds.

### BRIEF DESCRIPTION OF THE DRAWINGS

Exemplary embodiments of apparatuses and processes for the recovery of CO2 from a flue gas emitted from glass melting operations, glass melting systems that can incorporate such apparatuses and/or processes, glass manufacturing plants, glass melting apparatuses, glass manufacturing furnace arrangements, and methods of making and using the same are shown in the drawings included herewith. It should be understood that like reference characters used in the drawings may identify like components.

FIG. 1 is a block diagram of a first exemplary embodiment of a glass melting apparatus 1 that can utilize a first exemplary embodiment of an apparatus for the recovery of CO2 from a flue gas emitted from glass melting operations. A first exemplary embodiment of a process for the recovery of CO2 from a flue gas emitted from glass melting operations can also be appreciated from FIG. 1.

FIG. 2 is a block diagram of a second exemplary embodiment of a glass melting apparatus 1 that can utilize a second exemplary embodiment of an apparatus for the recovery of CO2 from a flue gas emitted from glass melting operations. A second exemplary embodiment of a process for the recovery of CO2 from a flue gas emitted from glass melting operations can also be appreciated from FIG. 2.

FIG. 3 is a block diagram of a third exemplary embodiment of a glass melting apparatus 1 that can utilize a third exemplary embodiment of an apparatus for the recovery of CO2 from a flue gas emitted from glass melting operations. A third exemplary embodiment of a process for the recovery of CO2 from a flue gas emitted from glass melting operations can also be appreciated from FIG. 3.

FIG. 4 is a block diagram illustrating an alkaline reagent regeneration system 13 that can be utilized in an exemplary process for alkaline reagent regeneration (also referred to as “XOH Regen.”). This exemplary embodiment of the alkaline reagent regeneration system 13 that can be utilized in the embodiments of FIGS. 1, 2, and 3 is also shown in broken line in FIGS. 1, 2, and 3.

FIG. 5 is a block diagram illustrating another embodiment of an alkaline reagent regeneration system 13 that can be utilized in an exemplary process for alkaline reagent regeneration (also referred to as “XOH Regen.”). This exemplary embodiment of the alkaline reagent regeneration system 13 that can be utilized in the embodiments of FIG. 1, 2, 3 or 4.

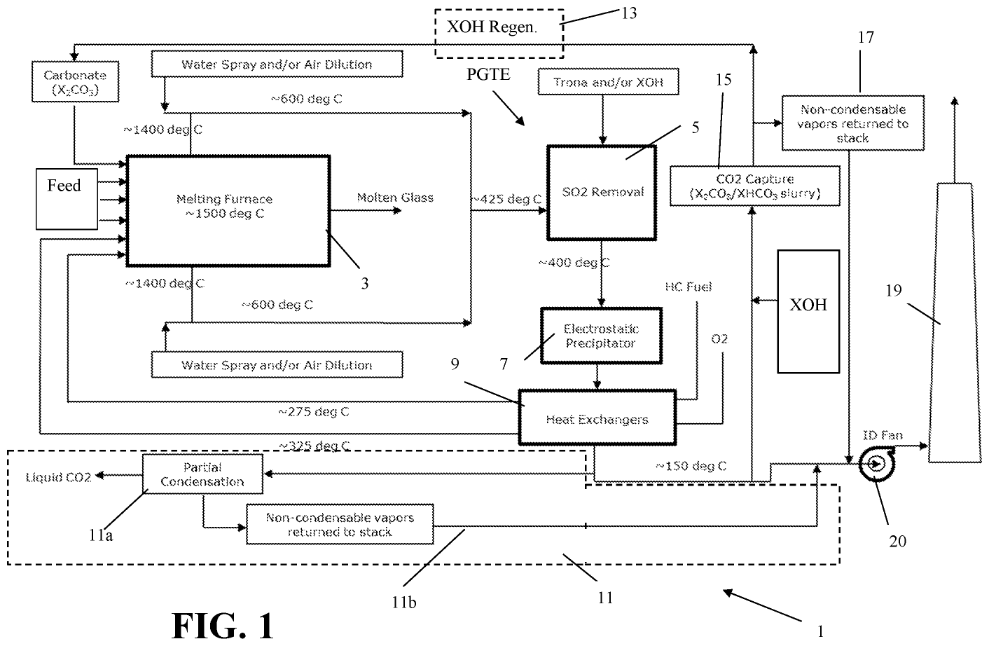

Exemplary process parameters (e.g. temperature, CO2 concentration, etc.) are identified in FIGS. 1-3. It should be appreciated that these are exemplary process parameters that provide non-limiting examples of how embodiments of the process and apparatus can be utilized.

### DETAILED DESCRIPTION

Referring to FIGS. 1-4, a glass melting apparatus 1 can include a furnace 3 that is for melting feed material to form molten glass. The feed material can include lime, cullet and batch raw glass feed material (e.g. silica, etc.). The feed material can also include liquid or solid hydrocarbons and carbonate material. The carbonate material fed to the furnace 3 can include limestone (CaCO3), dolomite (CaMg(CO3)2), soda ash (Na2CO3) and/or potassium carbonate (K2CO3).

Fuel (e.g. natural gas, etc.) and an oxidant (e.g. air, oxygen enriched air, a flow of gases that includes oxygen, etc.) can be fed to the furnace 3 to combust the fuel for heating the feed of glass raw materials within a cavity or chamber of the furnace 3 to form the molten glass.

Flue gas formed from the combustion of fuel for generating the heat in the furnace 3 to melt the feed material to form molten glass can be output from the furnace via at least one flue gas output. The temperature of the flue gas that is output from the furnace 3 can be very hot (e.g. a temperature within a pre-selected furnace flue gas output temperature range such as, for example, up to 1,400° C., between 1,000° C. and 1,400° C., between 1,000° C. and 1,500° C., or other furnace outlet temperature).

As can be appreciated from the embodiments of FIGS. 1-3, an apparatus for capturing CO2 from flue gas output from a glass melting furnace can include a CO2 capture unit 15 that is positionable downstream of the furnace 3 to receive a first portion of flue gas output from the furnace. The CO2 capture unit 15 can be configured so that the first portion of the flue gas reacts with at least one alkaline reagent within the CO2 capture unit so that CO2 of the first portion of the flue gas reacts with the at least one alkaline reagent to form at least one carbonate material. The CO2 capture unit 15 can be positionable such that at least a portion of the carbonate material is outputtable from the CO2 capture unit to feed the carbonate material to the furnace 3.

At least one process gas treatment element (PGTE) can be positionable between the CO2 capture unit 15 and the furnace 3 to receive the flue gas output from the furnace to treat the flue gas before the first portion of the flue gas is fed to the CO2 capture unit 15. At least one heat exchanger can also be positionable between the at least one PGTE 6 and the CO2 capture unit 15 so that flue gas output from the at least one PGTE 6 is passable through the at least one heat exchanger 9 to reduce a temperature of the flue gas before the first portion of the flue gas is fed to the CO2 capture unit 15. At least one acid gas removal unit 10 can be positionable to receive the flue gas upstream of the CO2 capture unit 15 to treat the flue gas to remove acid gas components from the flue gas before the first portion of the flue gas is treated by the CO2 capture unit 15. Embodiments can also utilize a CO2 liquefaction system 11 positionable to receive a second portion of the flue gas that can be split from the first portion of the flue gas after the flue gas is output from the at least one PGTE 6, at least one heat exchanger 9, or acid gas removal unit 10.

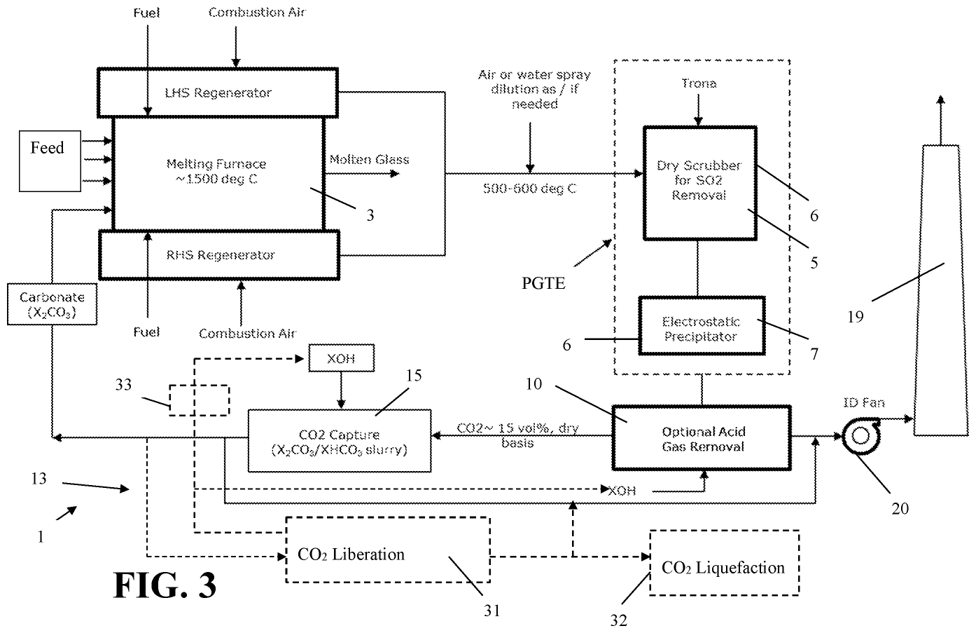

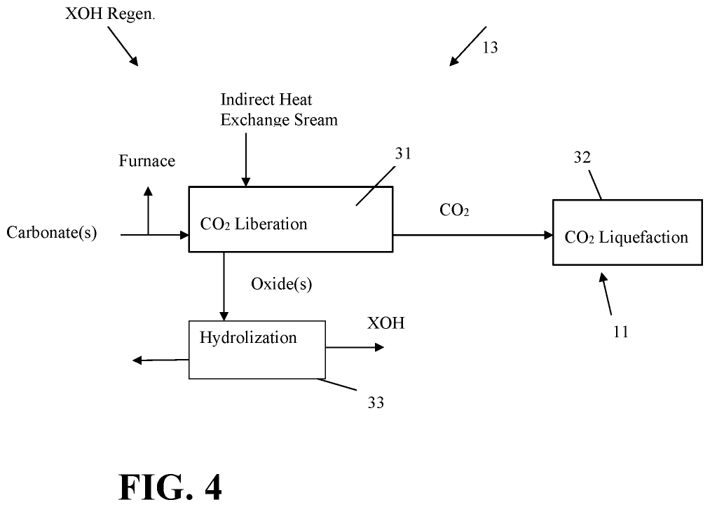

In some embodiments, the furnace 3 can receive a first portion of the carbonate material from the CO2 capture unit 15. An alkaline reagent regeneration system 13 that can be positioned downstream of the CO2 capture unit 15 to receive a second portion of the carbonate material to form the at least one alkaline reagent from the second portion of the carbonate material. As may best be appreciated from FIGS. 3 and 4, the alkaline reagent regeneration system can include a CO2 liberation device 31 that can liberate CO2 from the carbonate material to form oxides and a hydrolization unit 33 that can be positioned and configured to hydrolyze the oxides outputtable from the CO2 liberation device 31 to form the at least one alkaline reagent. The formed at least one alkaline reagent can be output from the hydrolization unit 33 so that the formed alkaline reagent is feedable to the CO2 capture unit 15.

The flue gas temperature from flue gas output from the furnace 3 can be reduced by diluting the flue gas with air and/or water that can be fed for direct contact with the flue gas to lower the temperature of the flue gas. A water spray and/or air dilution feed can be passed to the flue gas to directly contact the flue gas to lower its temperature, for example. The lowered flue gas temperature can be within a pre-selected flue gas transport temperature range that is suitable for being conveyed via a flue gas feed conduit to at least one process gas treatment element (PGTE) 6. The conduit can be metal ducts, an array of conduits and valves, or other conduit arrangement, for example. The at least one PGTE 6 can be positioned downstream of the furnace 3 and upstream of at least one heat exchanger 9 and also be positioned upstream of a carbon dioxide capture unit 15.

As can be appreciated from FIGS. 1-3, the at least one PGTE 6 can include a high-temperature filter device 8 (e.g. a filter device that has an operating temperature over 500° C., over 600° C., over 700° C., in a range of 500° C.-900° C., in a range of 600° C.-900° C., or in a range of 700° C. to 900° C., etc.) or can include an electrostatic precipitator 7 or other type of particulate filter (e.g. a baghouse) that is positioned in series with a sulfur dioxide (SO2) removal unit 5. The SO2 removal unit 5 can include a SO2 scrubber, a dry sorbent injection SO2 scrubber, a sorbent injection scrubber, or other device that can receive trona and/or the alkaline reagent (e.g. XOH) for removal of SO2 as well as other constituents (e.g. CO2) from the flue gas passed therethrough. It should be appreciated that trona is also referred to as trisodium hydrogendicarbonate dihydrate, and sodium sesquicarbonate dihydrate, (e.g. Na2CO3·NaHCO3·2H2O). Trona is a type of non-marine evaporite mineral.

XOH can include at least one alkaline reagent where X can be Na or K such that XOH can refer to KOH or NaOH. XOH can also refer to Ca(OH)2.

The temperature of the flue gas that is passed to at least one PGTE 6 can be within a pre-selected flue gas treatment temperature range. This temperature can be less than 450° C. in some embodiments or be in a range of 300° C. and 500° C. (e.g. be 425° C., 400° C., etc.). In embodiments where the at least one PGTE 6 includes the high-temperature filter device 8, the temperature can be higher as noted above (e.g. can be in the range of between 700° C. and 900° C. or in the range of 600° C. and 900° C.

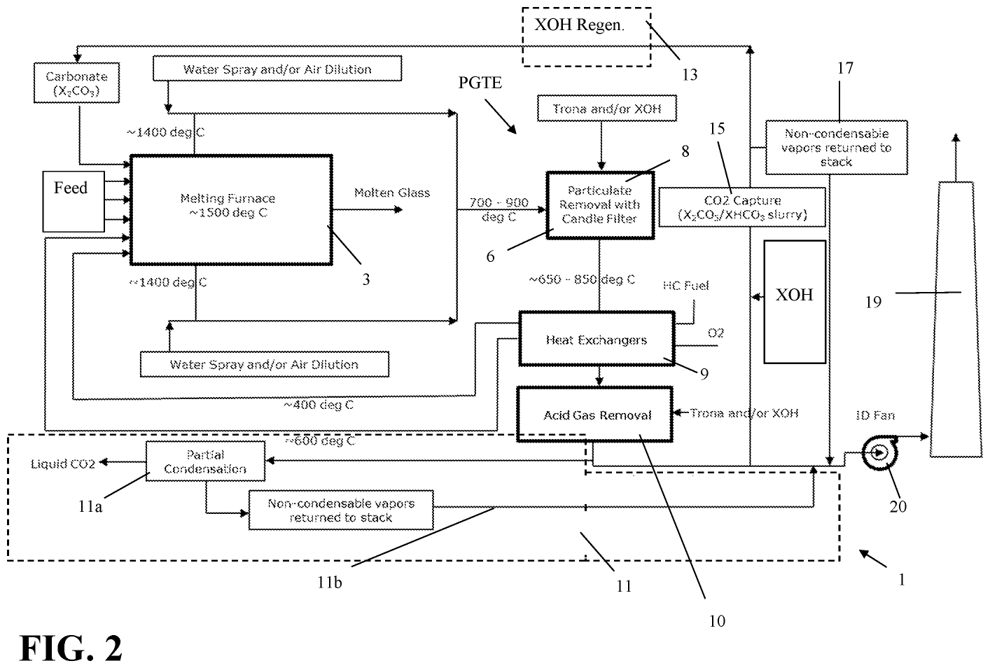

After the flue gas is output from at least one PGTE 6 in the embodiments of FIGS. 1-3, the flue gas can be fed to at least one heat exchanger 9 to cool the flue gas and heat one or more other process streams. For example, the flue gas can be passed through a heat exchanger to warm fuel and an oxidant flow (e.g. air, oxygen enriched air, etc.) before the oxidant and fuel are fed to the furnace for combustion of the fuel therein. After being output from the one or more heat exchangers 9, the flue gas can be fed to at least one acid gas removal devices (e.g. wash tower, scrubber, etc.). Trona and/or the alkaline reagent (e.g. XOH) can be fed to such devices to facilitate acid gas removal in some embodiments. FIGS. 2 and 3 illustrate examples of how at least one acid gas removal unit 10 can be positioned to treat the flue gas after the flue gas is output from the one or more heat exchangers 9, for example.

After being passed through one or more acid gas removal devices 10 or after being passed out of at least one heat exchanger 9, at least a portion of the flue gas can be passed through a CO2 capture unit 15. In some embodiments, the portion may be the entirety of the flue gas. In other embodiments, a first portion can be passed to the CO2 capture unit 15 and a second portion of the flue gas can be passed to a stack 19 for being emitted to atmosphere. The second portion may be passed to the stack 19 or may first be passed through a CO2 liquefaction system 11 before being passed to the stack 19. In yet other embodiments, a third portion of the flue gas can be passed from the heat exchanger 9 or at least one acid gas removal device 10 to a CO2 liquefaction system 11 (identified via broken line in FIGS. 1 and 2) for partial condensation of the flue gas in at least one condenser 11a for forming liquid CO2 and non-condensed vapors output from the condenser 11a. The non-condensed vapors can be fed back to the stack 19 via a vapor conduit 11b positioned between the stack 19 and the one or more condensers 11a.

For example, referring to the embodiments of FIGS. 1 and 3, the flue gas can be passed to an SO2 scrubber or other type of SO2 removal unit 5 and then output from the SO2 removal unit 5 to be fed to an electrostatic precipitator 7 or baghouse to remove particulates from the flue gas. Conduits can be arranged to interconnect the SO2 removal unit 5 and the electrostatic precipitator 7 so that flue gas output from the SO2 removal unit 5 can be fed to the precipitator 7. A heat exchanger feed conduit can connect the electrostatic precipitator 7 to one or more heat exchangers 9 for feeding the treated flue gas output from the electrostatic precipitator 7 to the one or more heat exchangers 9 for providing pre-heating to fuel and/or oxidant streams passed through the heat exchanger(s) 9 before the oxidant and fuel are fed to the furnace for being combusted therein for forming the molten glass. The flue gas output from the one or more heat exchangers 9 can be cooled as a result of the heating of the fuel and oxidant flows passed through the one or more heat exchangers 9.

Referring to the embodiment of FIG. 2, the flue gas can be passed from the furnace 3 to a high-temperature filter device 8 for particulate removal after the flue gas is cooled via air dilution and/or water spray. A conduit can connect the high-temperature filter device 8 to one or more heat exchangers 9 (not shown in FIG. 2) so that the flue gas output from the high-temperature filter device can be cooled while the heat from the flue gas is used to pre-heat fuel and/or an oxidant flow (e.g. O2, air, O2 enriched air, etc.) that is to be fed to the furnace for combustion of the fuel therein. It is also possible, as shown in FIG. 3 for example, that no such heat exchangers are utilized. Instead, the treated flue gas can be passed to an acid gas removal unit 10 and subsequently split into multiple streams for CO2 recovery or carbonate production.

Use of a high-temperature filter device 8 (e.g. a candle filter or other type of high-temperature filter device) as shown in FIG. 2 can provide some additional advantages. For example, the high-temperature filter device 8 can operate at a higher temperature and can be utilized for particulate removal in place of an electrostatic precipitator or baghouse. The higher temperature operation of the filter candle 8 relative to the typical operational temperature of an SO2 removal unit 5 and/or electrostatic precipitator 7 can enable a lower dilution of the flue gas that can provide at least three beneficial effects as compared to use of the SO2 removal unit 5 and/or electrostatic precipitator 7 that include:
(1) lowering total mass flow of the flue gas, which can reduce the size of downstream gas processing equipment;
(2) increase the CO2 concentration within the flue gas to facilitate the removal of CO2 relative to a more diluted CO2 stream; and
(3) provide a higher flue gas temperature that can enable higher proportion of waste energy to be recovered via heat exchangers (e.g. one or more heat exchangers 9) for other plant processes.

The CO2 concentration within the flue gas output from the at least one PGTE 6 and/or from the acid gas removal unit 10 can be relatively low for purposes of CO2 capture. For example, there can be a CO2 concentration of 15 vol % CO2 in the flue gas, a CO2 concentration in the range of 15 vol % to 75 vol % CO2 in the flue gas, or a CO2 concentration in the range of 10 vol % to 75 vol % CO2 in the flue gas. In some applications, the CO2 in the flue gas can be a CO2 concentration in the 10 vol % to 20 vol % range, or 12 vol % to 25 vol % range or be greater than the vol % range, for example.

The flue gas output from the one or more heat exchangers 9 or acid gas removal unit 10 can be subsequently processed for CO2 capture. In the embodiments of FIGS. 1 and 2, the flue gas output from the one or more heat exchangers 9 or acid gas removal unit 10 can be split into at least a first portion and a second portion. The first portion of the flue gas can be passed to a CO₂ capture unit 15 for CO₂ capture and a second portion of the flue gas can be passed to at least one condenser 11a of a CO₂ liquefaction system 11 for condensing of CO₂ of the flue gas of the second portion of the flue gas to form a liquid CO₂ stream. Non-condensed vapor output from the at least one condenser 11a can be passed to a stack 19 for emission to atmosphere via the vapor conduit 11b. A fan 20 can be connected to a non-condensed vapor conduit 11b connected between the stack 19 and the one or more condensers 11a to help facilitate the flow of the non-condensed vapor output from the at least one condenser 11a to the stack 19. The liquid CO₂ that is output from the one or more condensers 11a can be fed to a pipeline for transport or can be fed to a vessel for storage and subsequent transport or for storage for sequestration.

In some embodiments of the CO2 liquefaction system 11, the condensing of the CO2 can be performed such that the CO2 is solidified and output as solid material. CO2 solidification can occur in such embodiments based on the pressure and temperature operational parameters of the one or more condensers 11a.

In some embodiments, the flue gas can also include a split third portion that is fed directly to the stack 19 for emitting to the atmosphere. In other embodiments, there may not be such a third portion. In yet other embodiments, there may only be a first portion fed to a CO2 capture unit 15 and another portion that is fed to the stack 19. The portion fed to the stack 19 can be considered a second portion for the flue gas in such embodiments.

The first portion of the flue gas fed to the CO₂ capture unit 15 can pass through a CO₂ capture conduit positioned between the CO₂ capture unit 15 and the heat exchanger(s) 9 or acid gas removal unit 10 for being fed to the CO₂ capture unit 15. An alkaline reagent can be fed to the flue gas passing through the CO₂ capture conduit and/or fed to the CO₂ capture unit 15 for reacting with the CO₂ within the first portion of the flue gas. The alkaline regent can include XOH, for example. As discussed above, the alkaline reagent can react with the CO₂ within the flue gas to remove the CO₂ and form carbonates (e.g. XOH can react with the CO₂ of the flue gas to form X₂CO₃, XHCO₃, XCO₃, etc.). It should be appreciated that examples of the formed carbonates include CaCO₃, Na₂CO₃ or K₂CO₃. The formed carbonates can be within a slurry (e.g. a liquid) that is formed as a result of the reaction of the alkaline reagent with the CO₂ within the CO₂ capture unit 15. The non-condensed, or non-liquefied portion of the flue gas passed out of the CO₂ capture unit 15 can be output to the stack 19 for being emitted to the atmosphere. The liquefied portion having the carbonates therein can be passed to one or more heat exchangers or otherwise undergo heating to form carbonate material suitable for being fed to the furnace 3.

It should be appreciated that the CO₂ capture unit 15 can include a reactor that receives the alkaline reagent (e.g. XOH) and the first portion of the flue gas to facilitate the reaction of the reagent with the CO₂ of the flue gas to form the carbonate material. This formed material can include a slurry that includes XCO₃, X₂CO₃ and/or XHCO₃, for example. A furnace carbonate feed conduit can be connected between the CO₂ capture unit 15 and the furnace 3 for feeding the carbonate material output from the CO₂ capture unit 15 to the furnace 3.

In some embodiments, heat can be applied to the reactor to heat the formed carbonate slurry material to facilitate formation of carbonate material that can be reintroduced to the furnace 3 as a part of the carbonate feed material that is heated for the formation of the molten glass. In other embodiments, the formed slurry material output from the reactor can subsequently be heated via at least one heat exchanger to further heat the material so non-carbonate material within the slurry (e.g. XHCO3) can be heated to form into carbonate material prior to that material being fed to the furnace. In yet other embodiments, the slurry having carbonate material can be output from the CO₂ capture unit 15 for being fed to the furnace 3 for being heated therein for forming the molten glass material.

Not all of the vapor of the flue gas will be reacted with the alkaline reagent to form a carbonate containing slurry. The remaining vapor that is present after the reaction of the flue gas with the alkaline reagent can be output from the CO₂ capture unit 15 for being fed to the stack 19 as noted above. A fan 20 can be connected to a non-condensed vapor conduit 17 connected between the stack 19 and the CO₂ capture unit 15 to help facilitate the flow of the non-condensed vapor output from the CO₂ capture unit 15 to the stack 19.

As may best be appreciated from FIG. 3, some embodiments can include a furnace 3 that has a regenerative air-fuel furnace with optional oxygen lancing, boosting, or enrichment (e.g. a left hand side regenerator, or “LHS Regenerator” and a right hand side regenerator, or “RHS Regenerator”). Each regenerator can include a regenerator chamber in which a checkerwork of refractory bricks has been stacked or otherwise positioned. Fuel and combustion oxidant flows (e.g. air, etc.) can be cycled every regenerative air-fuel cycle time period (e.g. 20 minutes, every pre-selected time period in a range of 10 minutes and 30 minutes, etc.). While one of the regenerators can preheat the oxidant flow (e.g. combustion air), the other regenerator can recover heat from the flue gas. Fuel can be fed directly to one or more burner nozzles without any preheating in such an arrangement.

As may best be appreciated from FIGS. 1-4, embodiments can also be arranged and configured so that a portion of the carbonate material that is formed via the CO₂ capture unit 15 can be utilized to regenerate the alkaline reagent (e.g. XOH) for recycling back to the CO₂ capture unit 15 for use therein and/or for use in other process elements (e.g. acid gas removal unit 10, SO₂ removal unit 5). For example, embodiments can include an alkaline agent regeneration system 13, which is also be referred to as an “XOH Regen.” in FIGS. 1, 2 and 4. The alkaline agent regeneration system 13 can include a CO₂ liberation unit 31 that can receive an indirect heat exchange stream, which can include a hot process stream of fluid (e.g. steam, hot gas from a plant, etc.) to heat a portion of carbonate material output from the CO₂ capture unit 15. For instance, a first portion of the carbonate material output from the CO₂ capture unit 15 can be fed to the furnace 3 for being fed therein for forming molten glass material and a second portion of the carbonate material output from the CO₂ capture unit 15 can be fed to the CO₂ liberation unit 31 for being indirectly heated via the hot indirect heat exchange stream fed therein. The heating of the carbonate material can form oxide material that can be output from the CO₂ liberation unit 31 for being fed to a hydrolization unit 33 for hydrolyzing the oxides for forming the alkaline reagent (e.g. XOH) for outputting the XOH for being fed to the CO₂ capture unit 15 and/or other process elements that may utilize the alkaline reagent. Another output flow output from the hydrolization unit 33 that can include a byproduct flow that is a byproduct of the hydrolization of the oxide material for regeneration of the alkaline reagent. This byproduct flow can be output for subsequent use or treatment in the apparatus as well.

CO2 liberated from the carbonate material can be output within a vapor flow output from the CO2 liberation unit 31 for being fed to a CO2 liquefaction unit 32. In some embodiments, the CO2 liquefaction unit 32 can include the CO2 liquefaction unit system 11 (e.g. one or more condensers 11a, etc.). In other embodiments, the CO2 liquefaction unit 32 can be a separate CO2 liquefaction unit that can utilize one or more CO2 condensers for condensing the vapor output from the CO2 liberation unit. Non-condensed vapor output from the CO2 liquefaction unit 32 can be passed to the stack 19. The condensed CO2 can be passed to a pipeline, a storage vessel, or be further processed for solidification and/or sequestration.

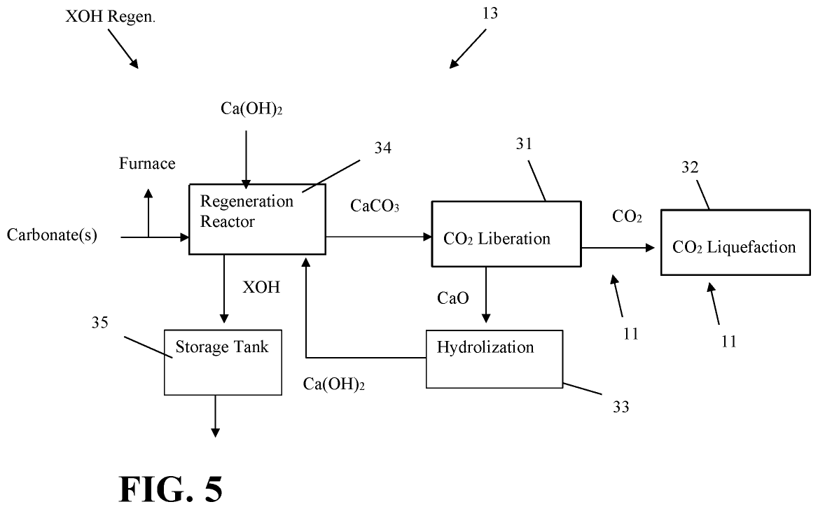

As may be appreciated from FIG. 5, the reagent regeneration system 13 can have other configurations. For instance, the reagent regeneration system 13 for either NaOH or KOH as the alkaline reagent, XOH can also be configured so that the resulting carbonate material or a portion of the carbonate material that is formed via the CO₂ capture unit 15 can be fed to a regeneration reactor 34 with hydrated lime Ca(OH)₂ as shown in FIG. 5. The reaction of the carbonate material with the hydrated lime in the reactor 34 can precipitate calcium carbonate (CaCO₃) while regenerating the alkaline reagent (XOH). The calcium carbonate can be fed into a CO₂ liberation unit 31 that is configured as a lime kiln or other suitable device that can be indirectly heated to a temperature within a pre-selected calcium carbonate CO₂ liberation temperature (e.g. a temperature of over 700° C.) to liberate the CO₂ and generate calcium oxide CaO, which then can be fed into a hydrolyzation unit 33 and the resulting hydrated lime can be recycled back into the regeneration reactor 34. The regenerated NaOH or KOH can be put into an intermediate storage tank 35 (not shown) and subsequently fed back into CO₂ capture unit 15. This type of regeneration process as shown in FIG. 5 can be applied to a CO₂ capture system from any flue gas and not limited to flue gas from glass furnaces.

The CO2 liberated from the calcium carbonate via the CO2 liberation unit 31 can be output within a vapor flow output from the CO2 liberation unit 31 for being fed to a CO2 liquefaction unit 32. In some embodiments, the CO2 liquefaction unit 32 can include the CO2 liquefaction unit system 11 (e.g. one or more condensers 11a, etc.). In other embodiments, the CO2 liquefaction unit 32 can be a separate CO2 liquefaction unit that can utilize one or more CO2 condensers for condensing the vapor output from the CO2 liberation unit. Non-condensed vapor output from the CO2 liquefaction unit 32 can be passed to the stack 19. The condensed CO2 can be passed to a pipeline, a storage vessel, or be further processed for solidification and/or sequestration.

Glass melting furnace systems and apparatuses for the recovery of CO2 from a flue gas emitted from glass melting operations that can be incorporated into the systems can be configured to include process control elements positioned and configured to monitor and control operations (e.g. temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the system, etc.).

Embodiments discussed herein can provide for an economical process for CO2 capture even for flows that have relatively low CO2 concentrations (e.g. concentration in the 10 vol % to vol % range, etc.). For example, conventional amine based processes often require substantial capital and operating costs that cannot be recovered using flows having such low CO2 concentrations. As an alternative to such conventional approaches, embodiments discussed herein can permit the captured CO2 to be economically reused for formation of carbonate material that can be used in the on-site glass making process (e.g. molten glass formation within furnace 3). This approach can avoid incurring such excessive costs and allow for reductions in raw material costs as well as other beneficial synergies while also allowing a significant reduction in greenhouse gas emissions from operation of the plant for making glass. Embodiments can also be configured so that sequestration or favorable geology required for such sequestration is not needed for economical capture of CO2 for reduction in greenhouse gas emissions. Further, embodiments can be configured so that use of a pipeline to provide for a commercially viable CO2 capture system is not required (though such a pipeline can be used in embodiments where such a use is warranted), which can permit a commercially viable reduction in greenhouse gas emissions in glass melting operations in a wider array of settings and plant locations.

It should be appreciated that different embodiments can be configured to meet a particular set of design criteria. For example, a particular set of pressure, temperature and flow rate criteria can be adjusted for different process elements of the apparatus for use in an embodiment of our process to meet a particular set of design criteria. As another example, the type and arrangement of various process elements (e.g. heat exchangers, pumps, fans, conduits, furnace 3, PGTE 6, etc.) can be adapted to meet a particular set of design criteria. As yet another example, the type of reactor that may be utilized as a CO2 capture unit 15 or type of unit to utilize for the acid gas removal unit 10 or SO2 removal unit 5 can be any of a number of suitable options that may be used to meet a particular set of design criteria.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a glass melting plants, apparatuses and processes for the recovery of CO2 from a flue gas emitted from glass melting operations, glass manufacturing furnace arrangements, and methods of making and using the same have been shown and described above, it is to be distinctly understood that the invention is not limited thereto but may be otherwise variously embodied and practiced within the scope of the following claims.

1. A method of recovering carbon dioxide (CO₂) from a flue gas output from a furnace being operated to melt glass, comprising:
feeding the flue gas to a CO₂ capture unit after the flue gas is treated via at least one process gas treatment element (PGTE) positioned between the furnace and the CO₂ capture unit;
treating a first portion of the flue gas with at least one alkaline reagent within the CO₂ capture unit so that CO₂ of the first portion of the flue gas reacts with the alkaline reagent to form at least one carbonate material;
feeding at least a portion of the carbonate material from the CO₂ capture unit to the furnace for mixing with other feed material for forming molten glass in the furnace.

2. The method of claim 1, wherein the at least one alkaline reagent includes XOH, wherein the X is Na or K.

3. The method of claim 1, wherein the at least one alkaline reagent includes: calcium hydroxide (Ca(OH)₂), sodium hydroxide (NaOH) or potassium hydroxide (KOH).

4. The method of claim 3, wherein the carbonate material includes limestone (CaCO₃), soda ash (Na₂CO₃) or potassium carbonate (K₂CO₃).

5. The method of claim 4, wherein the at least one PGTE includes a candle filter or a high-temperature filter device.

6. The method of claim 4, wherein the at least one PGTE includes a SO₂ removal unit and an electrostatic precipitator that is positioned between the SO₂ removal unit and the CO₂ capture unit.

7. The method of claim 1, comprising:
passing the flue gas through at least one heat exchanger to heat at least one of a flow of fuel and an oxidant flow before the first portion of the flue gas is fed to the CO₂ capture unit and after the first portion of the flue gas is output from the at least one PGTE.

8. The method of claim 1, comprising:
feeding a first portion of the carbonate material output from the CO₂ capture unit to the furnace and regenerating a second portion of the carbonate material output from the CO₂ capture unit to form the at least one alkaline reagent from the second portion of the carbonate material.

9. The method of claim 1, comprising:
feeding a second portion of the flue gas output from the at least one PGTE to a CO₂ liquefaction system to liquefy CO₂ within the second portion of the flue gas.

10. The method of claim 1, wherein the at least one PGTE is fed at least one alkaline reagent to treat the flue gas upstream of the CO₂ capture unit.

11. An apparatus for capturing carbon dioxide (CO₂) from a flue gas output from a melting furnace, the apparatus comprising:
a CO₂ capture unit positionable downstream of the furnace to receive a first portion of flue gas output from the furnace, the CO₂ capture unit configured so that the first portion of the flue gas reacts with at least one alkaline reagent within the CO₂ capture unit so that CO₂ of the first portion of the flue gas reacts with the at least one alkaline reagent to form at least one carbonate material;
the CO₂ capture unit positionable such that at least a portion of the carbonate material is outputtable from the CO₂ capture unit to feed the carbonate material to the furnace.

12. The apparatus of claim 11, wherein the at least one alkaline reagent includes calcium hydroxide (Ca(OH)₂), sodium hydroxide (NaOH) and potassium hydroxide (KOH).

13. The apparatus of claim 12, wherein the carbonate material includes limestone (CaCO₃), soda ash (Na₂CO₃) and/or potassium carbonate (K₂CO₃).

14. The apparatus of claim 11, wherein the CO₂ capture unit includes at least one reactor.

15. The apparatus of claim 11, comprising:
at least one process gas treatment element (PGTE) positionable between the CO₂ capture unit and the furnace to receive the flue gas output from the furnace to treat the flue gas before the first portion of the flue gas is fed to the CO₂ capture unit.

16. The apparatus of claim 15, comprising:
at least one heat exchanger positionable between the at least one PGTE and the CO₂ capture unit so that flue gas output from the at least one PGTE is passed through the at least one heat exchanger to reduce a temperature of the flue gas before the first portion of the flue gas is fed to the CO₂ capture unit.

17. The apparatus of claim 16, comprising:
at least one acid gas removal unit positionable to receive the flue gas upstream of the CO₂ capture unit.

18. The apparatus of claim 15, comprising:
a CO₂ liquefaction system positionable to receive a second portion of the flue gas that is split from the first portion of the flue gas after the flue gas is output from the at least one PGTE.

19. The apparatus of claim 11, wherein a first portion of the carbonate material is feedable to the furnace and the apparatus comprising:
an alkaline reagent regeneration system downstream of the CO₂ capture unit to receive a second portion of the carbonate material to form the at least one alkaline reagent from the second portion of the carbonate material.

20. The apparatus of claim 19, wherein the alkaline reagent regeneration system comprises:
a CO₂ liberation device that liberates CO₂ from the carbonate material to form oxides; and
a hdyrolization unit to hydrolyze the oxides outputtable from the CO₂ liberation device to form the at least one alkaline reagent such that the formed at least one alkaline reagent is feedable to the CO₂ capture unit.

21. A method of recovering carbon dioxide (CO₂) from a flue gas output from a furnace or reactor, comprising:
feeding the flue gas to a CO₂ capture unit after the flue gas is treated via at least one process gas treatment element (PGTE) positioned between the furnace or reactor and the CO₂ capture unit;
treating a first portion of the flue gas with at least one alkaline reagent within the CO₂ capture unit so that CO₂ of the first portion of the flue gas reacts with the alkaline reagent to form at least one carbonate material;
feeding a first portion of the carbonate material from the CO₂ capture unit to an alkaline reagent regeneration system;
reacting the first portion of the carbonate material with hydrated lime (Ca(OH)₂) in a reagent regeneration reactor of the alkaline reagent regeneration system to precipitate calcium carbonate (CaCO₃) and liberate the alkaline reagent for feeding to the CO₂ capture unit;
heating the CaCO₃ in a CO₂ liberation unit or a lime kiln to liberate CO₂ from the CaCO₃ and generate calcium oxide (CaO); and
hydrolyzing the CaO to form Ca(OH)₂ to feed the formed Ca(OH)₂ to the reagent regeneration reactor of the alkaline reagent regeneration system.

22. An apparatus for capturing carbon dioxide (CO₂) from a flue gas output from a furnace or reactor, the apparatus comprising:
a CO₂ capture unit positionable downstream of the furnace or reactor to receive a first portion of flue gas output from the furnace, the CO₂ capture unit configured so that the first portion of the flue gas reacts with at least one alkaline reagent within the CO₂ capture unit so that CO₂ of the first portion of the flue gas reacts with the at least one alkaline reagent to form at least one carbonate material;
an alkaline reagent regeneration system downstream of the CO₂ capture unit, the alkaline reagent regeneration system comprising:
a regeneration reactor positioned to receive the carbonate material to react the carbonate material with hydrated lime (Ca(OH)₂) to precipitate calcium carbonate (CaCO₃) and liberate the alkaline reagent for feeding to the CO₂ capture unit;
a CO₂ liberation unit positioned to receive the CaCO₃ from the regeneration reactor of the alkaline reagent regeneration system to liberate CO₂ from the CaCO₃ and generate calcium oxide (CaO);
a hydrolysis unit positioned to receive the CaO to hydrolyze the CaO to form Ca(OH)₂ so the formed Ca(OH)₂ is feedable to the regeneration reactor.
